(19) United States
(12) Patent Application Publication
(10) Pub. No.: US 2023/0012224 A1
(43) Pub. Date: Jan. 12, 2023

(54) ZERO FOOTPRINT VPN-LESS ACCESS TO INTERNAL APPLICATIONS USING PER-TENANT DOMAIN NAME SYSTEM AND KEYLESS SECURE SOCKETS LAYER TECHNIQUES

(71) Applicant: Citrix Systems, Inc., Fort Lauderdale, FL (US)

(72) Inventors: Krishna Kumar, Sunnyvale, CA (US); Anil Kumar Gavini, Milpitas, CA (US); Arkesh Kumar, San Jose, CA (US); Kiran Kumar Srinivasa, San Jose, CA (US); Srinivasa Maddipati, San Jose, CA (US)

(73) Assignee: Citrix Systems, Inc., Fort Lauderdale, FL (US)

(21) Appl. No.: 17/370,225

(22) Filed: Jul. 8, 2021

(51) Int. Cl. H04L 29/06; H04L 29/12

(52) U.S. Cl. CPC H04L 63/10; H04L 63/0823; H04L 63/0281; H04L 61/1511; H04L 61/2007; H04L 12/4641

(57) ABSTRACT

Described embodiments provide systems and methods for accessing a web application hosted in an intranet from outside said intranet. A server hosting a domain name service configured for the intranet can receive a request from a client that is outside the intranet to access the web application. The request may include a fully qualified domain name (FQDN) of the web application in the intranet. Responsive to the FQDN of the web application in the intranet, the server may send a notification to an access service, to cause the access service to pre-establish a connection to the intranet. Responsive to the FQDN of the web application in the intranet, the server may direct the client to send a handshake message to the access service to request access to the web application.

### FIELD OF THE DISCLOSURE

The present application generally relates to accessing applications, including but not limited to systems and methods for accessing applications hosted in an intranet from outside the intranet.

### BACKGROUND

Certain systems can provide access to internal or private applications, such as an application hosted in a private network, from an external network. Some of the systems can establish or configure a communication channel to access a private application, for example a virtual private network (VPN) tunnel, via at least one agent. In certain scenarios, the systems may require complicated domain names, as well as registration and/or management solutions for the domain names, to access and/or use an internal application. With said approaches, there can be an inability to provide access to private applications without using additional technology, such as an agent, and/or while using practical domain names.

### SUMMARY

This Summary is provided to introduce a selection of concepts in a simplified form that are further described below in the Detailed Description. This Summary is not intended to identify key features or essential features, nor is it intended to limit the scope of the claims included herewith.

The present disclosure is directed towards systems and methods for accessing an application (e.g., an application resource, such as a web application, SaaS application and/or remote-hosted network application) from outside an intranet without an agent (e.g., client agent 120 and/or other monitoring agents). According to the systems and methods described herein, in order to access an application hosted in an intranet, a server hosting a domain name service (DNS), and/or an access service (e.g., Secure Workspace Access (SWA), and/or other services providing conditional access to cloud/web applications), can facilitate pre-establishment of a connection to the intranet to accelerate connection establishment upon receiving a request (e.g., a request to access an application). In one example, a client (e.g., a smartphone, a laptop, a tablet device, a desktop computer of a user, and/or a client supporting HTTP/HTTPS) that is outside the intranet (e.g., a private network, such as a corporate/organization network) may attempt to access and/or use a web application hosted in said intranet. The systems and methods presented herein can provide the client with access to the web application, without using a VPN connection for instance, by using a DNS server configured for the intranet (e.g., a per-tenant DNS) to resolve a fully qualified domain name (FQDN) of a published web application (e.g., published via the access service). As such, the DNS server and/or the access service can provide the client with access to the published web application, even if the client is outside the intranet.

In one aspect, the present disclosure is directed to a method for accessing a web application from outside an intranet in which the web application is hosted. The method can include receiving, by a server hosting a domain name service (DNS) configured for an intranet, a request from a client that is outside the intranet to access a web application hosted in the intranet. The request may include a fully qualified domain name (FQDN) of the web application in the intranet. Responsive to the FQDN of the web application in the intranet, the server may send a notification to an access service, to cause the access service to pre-establish a connection to the intranet. Responsive to the FQDN of the web application in the intranet, the server may direct the client to send a handshake message to the access service to request access to the web application.

In some embodiments, sending the notification may comprise sending, by the server, the notification prior to the client sending the handshake message to the access service. In some embodiments, the request may include an anycast internet protocol (IP) address corresponding to the server. In certain embodiments, the server may resolve the FQDN to a global FQDN of the access service. The server may send a message to the client to redirect the client to the access service. In some embodiments, the server may receive a message from the access service to add or remove the FQDN of the web application. In certain embodiments, another server hosting a DNS configured for another intranet may receive a request from another client that is outside the another intranet to access a web application hosted in the another intranet. The request may include a FQDN of the web application in the another intranet. The another server may send a notification to another access service, to cause the another access service to pre-establish a connection to the another intranet. The another server may direct the another client to send a handshake message to the another access service to request access to the web application in the another intranet.

In certain embodiments, the method may comprise causing the access service to pre-establish the connection to the intranet using a connector having a connection to an application server hosting the web application. In some embodiments, the method may comprise causing the access service to request or receive a client certificate from the client, the client certificate including information associated with the intranet. The method can comprise causing the access service to identify the pre-established connection using the information associated with the intranet and an indication of the FQDN in the handshake message. In some embodiments, the access service may access a key server or at least one session key for the pre-established connection.

In one aspect, the present disclosure is directed to a server hosting a domain name service (DNS) configured for accessing a web application from outside an intranet in which the web application is hosted. The server may comprise at least one processor. The at least one processor may be configured to receive a request from a client that is outside the intranet to access a web application hosted in the intranet. The request may include a fully qualified domain name (FQDN) of the web application in the intranet. The at least one processor may be configured to send, responsive to the FQDN of the web application in the intranet, a notification to an access service, to cause the access service to pre-establish a connection to the intranet. Responsive to the FQDN of the web application in the intranet, the at least one processor may be configured to direct the client to send a handshake message to the access service to request access to the web application.

In some embodiments, the at least one processor may be configured to send the notification prior to the client sending the handshake message to the access service. In certain embodiments, the request may include an anycast internet protocol (IP) address corresponding to the server. In some embodiments, the at least one processor may be configured to resolve the FQDN to a global FQDN of the access service. The at least one processor may be configured to send a message to the client to redirect the client to the access service. In certain embodiments, the at least one processor may be configured to receive a message from the access service to add or remove the FQDN of the web application. In some embodiments, another server hosting a DNS configured for another intranet may be configured to receive a request from another client that is outside the another intranet to access a web application hosted in the another intranet. The request may include a FQDN of the web application in the another intranet. The another server may be configured to send a notification to another access service, to cause the another access service to pre-establish a connection to the another intranet. The another server may be configured to direct the another client to send a handshake message to the another access service to request access to the web application in the another intranet.

In some embodiments, the at least one processor may be configured to cause the access service to pre-establish the connection to the intranet using a connector having a connection to an application server hosting the web application. The at least one processor may be configured to cause the access service to request or receive a client certificate from the client, the client certificate including information associated with the intranet. The at least one processor may be configured to cause the access service to identify the pre-established connection using the information associated with the intranet and an indication of the FQDN in the handshake message. In some embodiments, the access service may access a key server or at least one session key for the pre-established connection.

In one aspect, the present disclosure is directed to a non-transitory computer readable medium storing program instructions for accessing a web application from outside an intranet in which the web application is hosted. The program instructions stored in a non-transitory computer readable medium may cause at least one processor to receive a request from a client that is outside the intranet to access a web application hosted in the intranet. The request may include a fully qualified domain name (FQDN) of the web application in the intranet. The at least one processor may reside in a server hosting a domain name service configured for an intranet. The program instructions can cause the at least one processor to send, responsive to the FQDN of the web application in the intranet, a notification to an access service, to cause the access service to pre-establish a connection to the intranet. Responsive to the FQDN of the web application in the intranet, the program instructions can cause the at least one processor to direct the client to send a handshake message to the access service to request access to the web application. In some embodiments, the program instructions can cause the at least one processor to resolve the FQDN to a global FQDN of the access service. The program instructions can cause the at least one processor to send a message to the client to redirect the client to the access service.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 1D is a block diagram depicting a computing environment comprising client device in communication with cloud service providers, in accordance with an illustrative embodiment;

FIG. 2 is a block diagram of an appliance for processing communications between a client and a server, in accordance with an illustrative embodiment;

FIG. 3 is a block diagram of a system for accessing an application from outside an intranet, in accordance with an illustrative embodiment;

FIG. 4 is a communication diagram of a system for accessing an application from outside an intranet, in accordance with an illustrative embodiment; and

FIG. 5 is a flow diagram of an example method for accessing an application from outside an intranet, in accordance with an illustrative embodiment.

### DETAILED DESCRIPTION

Current systems and/or technologies can provide access to internal/private applications, such as a web application hosted in an intranet (e.g., a corporate datacenter, a private backend server, and/or a corporate/organization network), from outside said intranet. Some of the systems may use an agent (for instance, a VPN client/agent) to establish and/or configure a connection (e.g., VPN tunnel) for accessing and/or using the private application. In some scenarios, the systems (e.g., server and/or client rewrite technologies) may require complicated and/or non-user-friendly domain names (e.g., fully qualified domain name (FQDN)), as well as registration and/or management solutions for the domain names, to access and/or use an internal application. At least one problem with said approaches is an inability to provide access to private applications without an agent and/or complicated domain names. The systems and methods presented herein include a novel approach for accessing an application (e.g., an application resource, such as a web application, SaaS application and/or remote-hosted network application) from outside an intranet without an agent (e.g., client agent 120 and/or other monitoring agents), and/or while using user-friendly FQDNs. In one example, a user of a client (e.g., a web browser) may access a private web application from outside the intranet by providing, specifying, and/or indicating a FQDN of the web application via the client (e.g., a web browser), wherein the specified FQDN corresponds to the FQDN used when accessing the application from inside the intranet. As such, the user can access and/or use the private web application from outside the intranet without using a client agent.

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for accessing an application hosted in an intranet from outside the intranet.

### A. Network and Computing Environment

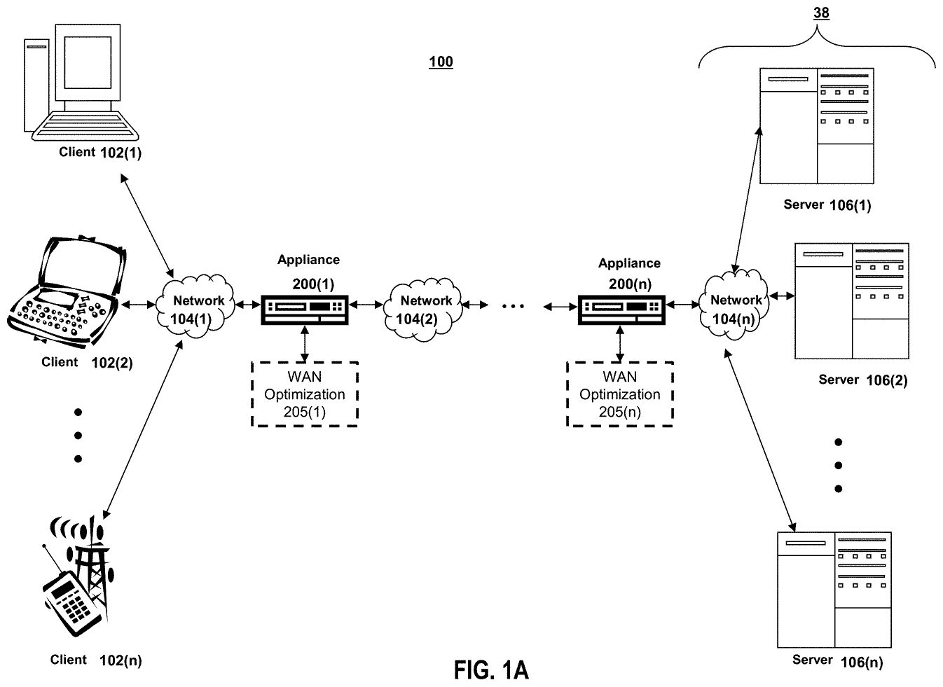

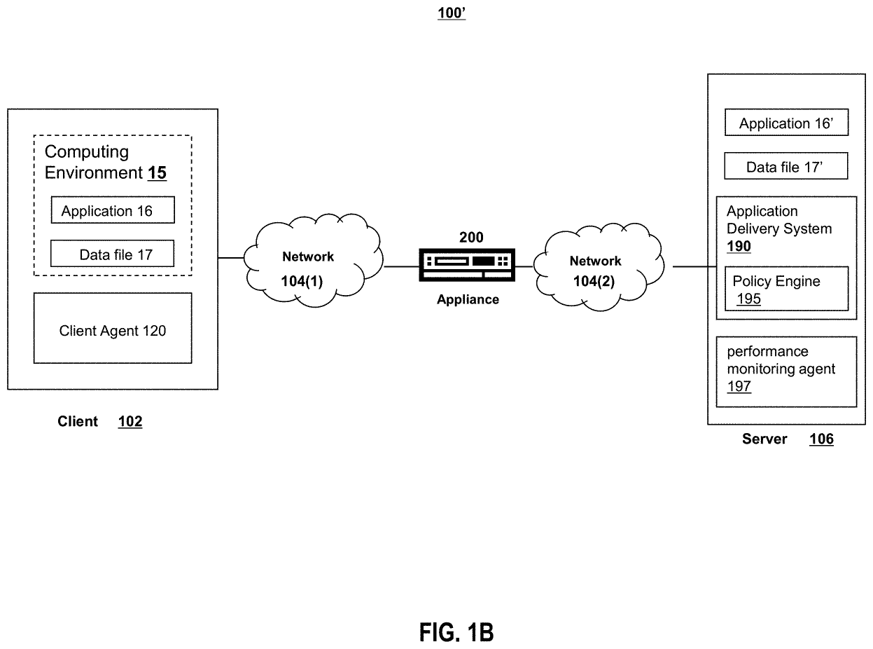

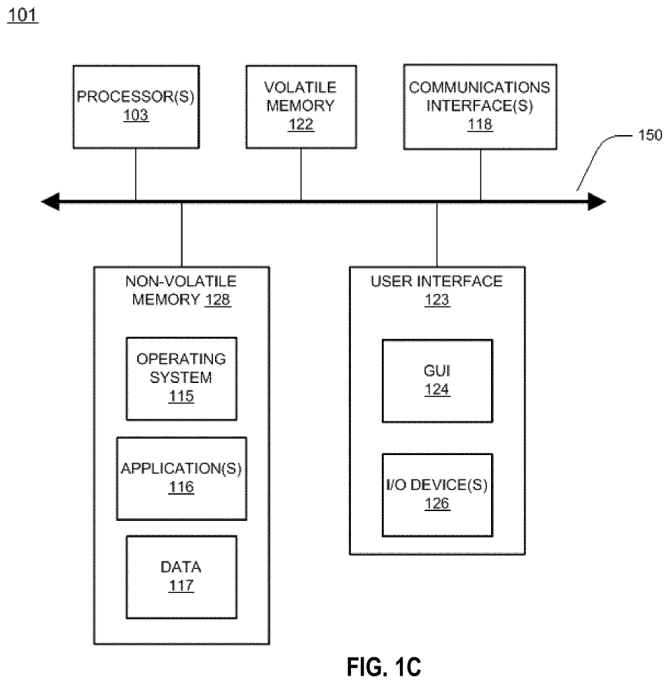

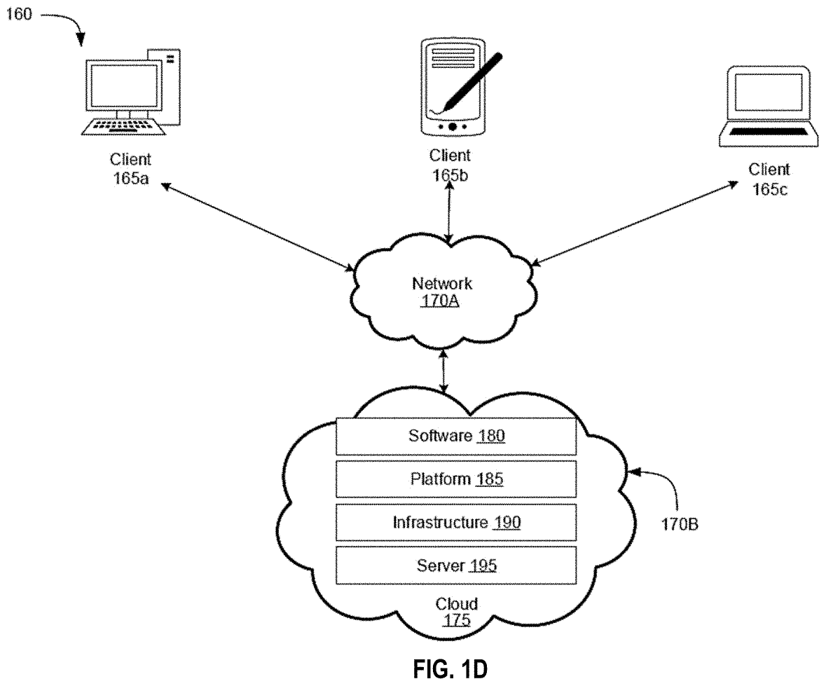

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, Fla.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace SuiteTM by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, Fla. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, Fla.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, Fla., the teachings of which are hereby incorporated herein by reference.

Referring to FIG. 1D, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms or data centers. The clients 165 can be the same as or substantially similar to computer 100 of FIG. 1C.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Appliance Architecture

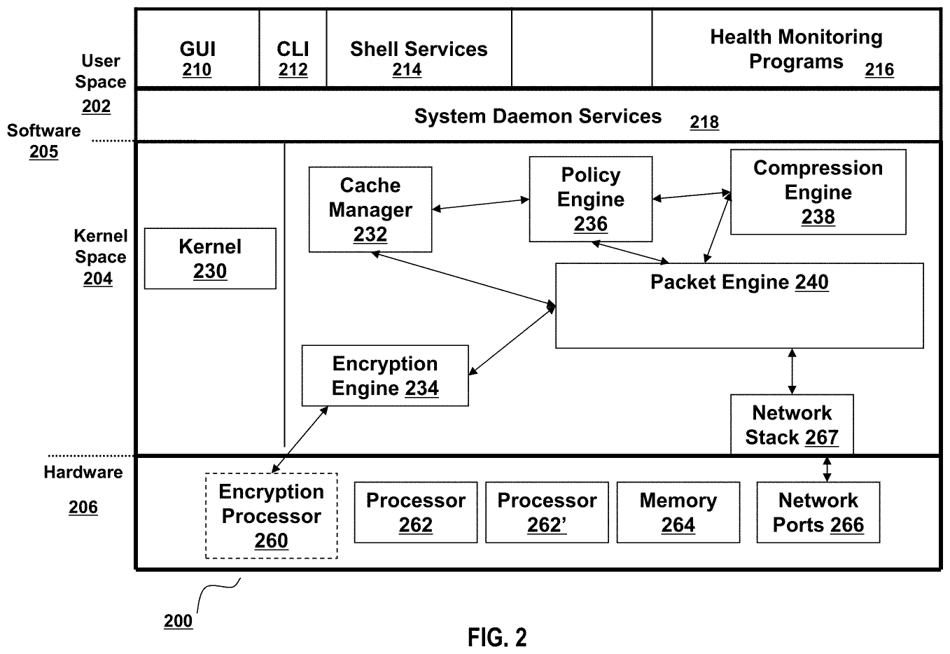

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, Fla. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, Fla., the teachings of which are hereby incorporated herein by reference.

C. Systems and Methods for Accessing an Application from Outside an Intranet

The systems and methods presented herein include a novel approach for accessing and/or using an application (e.g., a web application, a SaaS application, a cloud application, and/or other applications) hosted in an intranet (e.g., a private network, such as LAN or a company/organization intranet) from outside the intranet. The novel approach includes one or more mechanisms to resolve a FQDN of an application (e.g., hosted in the intranet) by using (or according to) a DNS server configured for the intranet (e.g., per-tenant DNS) and/or an access service (e.g., SWA and/or other services that provide access to applications). Therefore, the novel approach may provide a client with access to a private and/or internal application without using or installing an agent (e.g., client agent 120 and/or other monitoring agents) on the client for instance.

In some embodiments of the present solution, a server hosting a DNS configured for an intranet (e.g., a per-tenant DNS server and/or a global DNS) can include a resolver (e.g., DNS resolver service hosted in a cloud). At least one tenant (e.g., referring to a specific corporate entity, organization, etc.) may use and/or access a particular server hosting a DNS configured for an intranet (e.g., DNS server) and/or a DNS resolver. A tenant may include or correspond to one or more users of a network (e.g., an intranet of a corporate entity, organization, etc.) that share a common access (e.g., with specific privileges) to an application, such as a web application. In some embodiments, each tenant of the DNS resolver may receive and/or obtain a unique anycast internet protocol (IP) address (and/or other types of addresses). The unique anycast IP address may correspond to (e.g., unique to and/or related to) the DNS server. The anycast IP address can be used to direct, route, send, forward, and/or transmit a DNS request from a client device (e.g., a smartphone, a laptop, a tablet device, a desktop computer of a user, and/or a client supporting HTTP/HTTPS) of the tenant to the DNS instance (e.g., DNS server) located nearest/closest to the client device. Furthermore, using an anycast IP address for the intranet and/or DNS server may ensure canonical name (CNAME) lookups have a source location nearest to the client device. Moreover, anycast IP addresses can aid in avoiding unexpected routing in scenarios with intelligent traffic routing (e.g., I™).

In certain embodiments, each tenant of the DNS server may have access to and/or control over one or more DNS entries of the corresponding/particular tenant. For instance, a tenant can control the tenant's own DNS entries, without having access to the DNS entries of another tenant. The proposed solution can automatically populate and/or manage the DNS entries, without additional DNS management and/or configuration by an administrator (e.g., a tenant administrator). In some embodiments, a user of a tenant may configure one or more client devices to specify and/or indicate that an assigned anycast IP address (e.g., assigned to each tenant) corresponds to (e.g., is unique to and/or related to) the DNS server. Management solutions, such as endpoint management solutions (e.g., Citrix endpoint management (CEM)), can be used by one or more clients to configure/specify the relationship between the assigned anycast IP address and the DNS server. Responsive to configuring the client(s), the DNS server can resolve the FQDN of one or more applications (e.g., published web applications) on the client(s), wherein the client(s) can be inside or outside the intranet (e.g., intranet hosting the application(s)). The DNS server can use an address (e.g., a source IP address) to determine and/or detect whether the client is inside the intranet (e.g., internal to a corporate network). If the client is inside the intranet, the DNS server may be able to resolve a FQDN of an unpublished application (e.g., unpublished in the access service).

In certain embodiments, an administrator may publish and/or release an internal application via the access service (e.g., SWA service). If the administrator publishes the internal application via the access service, the access service may send a message to the DNS server (e.g., the server hosting the DNS configured for the intranet), to provide, specify, and/or indicate the FQDN of the published application. Responsive to the message, the DNS server may add, incorporate, and/or include the FQDN of the published application. The incorporated FQDN can map and/or link to the public FQDN of the access service. If, for example, the internal application is removed via the access service, the access service may remove (e.g., via a message/instruction) the corresponding DNS entry (e.g., the incorporated FQDN) from the DNS server.

In some embodiments, a DNS server may be configured for each tenant. By configuring a DNS server for each tenant (or a group of tenants in some implementations), a user of a client (e.g., client outside an intranet) can indicate a FQDN of an internal application (e.g., web application hosted in the intranet) via a web browser, for example, without installing and/or using a client agent. The provided FQDN (e.g., internal FQDN) may resolve to the FQDN of the access service (e.g., global FQDN), and as such, a request (e.g., from a client) to access the internal application can be directed, forwarded, and/or routed to the access service. The DNS server (e.g., per-tenant DNS) may notify and/or inform the access service of the potential incoming request to access the internal application for a given tenant (e.g., inferred from the IP address of the DNS server). Responsive to the notification, the access service may pre-establish and/or pre-configure at least one connection (e.g., backend connection) to the intranet (e.g., corporate network, connector, and/or server of the application).

In some embodiments, the access service may pre-establish the connection(s) to the intranet using at least one connector (e.g., an intermediary device and/or a network appliance 200). The connector(s) may have a connection to a server (e.g., backend server, application server) hosting the application, for instance. Pre-establishing the connection can accelerate connection establishment once the actual request (e.g., handshake message) to access the internal application is received by the access service. In some embodiments, the pre-established connection(s) can be used (e.g., to access/use an application) if the received request is determined to be valid. A request can be validated and/or authenticated (e.g., by the access service, the connector, and/or the server) once the connection request lands on (e.g., is received by) the access service.

To prevent a denial-of-service (DOS) attack (e.g., opening/initiating/establishing a plurality of connections with a connector to overload a system), a connection may be pre-established if the request (e.g., request to access an application and/or to establish a connection) originates from a trusted IP address. The server, access service, and/or the connector may determine the level of trustworthiness of an IP address over time. For instance, the server may determine an IP address is trustworthy if, over time, a plurality of requests to access one or more applications originate from a same IP address. In some embodiments, the server, access service, and/or connector can minimize the risk of DOS attacks by limiting the number of established connections to 1 (or other values) connection per resource location (RL). The access service may determine an amount, quantity, and/or number of connections that are open to a particular RL.

In some embodiments, the access service may request, receive, and/or obtain a client certificate from the client to establish a connection to the intranet. The client certificate can be a trusted certificate, and/or can include/provide/specify information associated with the intranet (e.g., tenant information). Responsive to receiving a request to access an application, the access service may identify, extract, and/or determine the information associated with the intranet from the client certificate. Furthermore, the access service may determine the FQDN of the corresponding application (e.g., application specified by the received request) according to an indication of the FQDN, such as a server name indication (SNI) of the request. In certain embodiments, the access service may use the information associated with the intranet and/or the determined FQDN to determine whether at least one connection has been pre-established for the corresponding application. If no such connections are available, the access service may establish one or more connections to a server, such as a backend and/or application server, hosting one or more applications (including the application specified by the received request). In some embodiments, management solutions (e.g., CEM) can be used to distribute and/or provide the client certificate to one or more client devices, for example.

During a handshake between the client and the backend server, the access service may obtain one or more secure sockets layer (SSL) session keys for the connection. The SSL session key(s) can be used to transparently intercept and/or inspect traffic from/to the application (e.g., to provide services, such as single sign-on (SSO) and/or web filtering functionalities). In some embodiments, keyless SSL technology can be used to perform the interception and/or inspection of traffic associated to the application. A key server for keyless SSL technology may be accessed via (or by using) one or more connectors (e.g., one or more gateway devices for a tenant). In some embodiments, the key server can be hosted and/or managed (e.g., by a customer) using a cloud-based solution/service.

In some embodiments, the client can be located inside the intranet (e.g., a corporate network). A client that is inside the intranet can resolve the FQDN of a published application (e.g., published via the access service). If the client is resolving said FQDN, the DNS server can resolve a request to access the published application to a connector (e.g., instead of to the access service). The connector can redirect and/or send the traffic associated with the application to the access service, including tenant context for authentication, if required. After authenticating the request, the request can be sent, directed, routed, and/or transmitted to a connector that is inside the intranet, which will facilitate SSO and/or accessibility to the backend server. In some embodiments, the DNS server may receive and/or obtain a request to access an unpublished application (e.g., unpublished via the access service). The request can include, provide, specify, and/or indicate the FQDN of the unpublished application and/or other information. If the DNS server receives a FQDN for an unpublished application, the DNS server may send, transmit, and/or forward the request to at least one connector for resolving the FQDN. The DNS server may forward the request to at least one connector if the request originates from inside the intranet.

In some embodiments, the systems and methods presented herein can include a single global DNS server, instead of a DNS server configured for each tenant (e.g., configured for an intranet). By using a single global DNS server, one or more customers (e.g., tenants, or users of one or more tenants) can use and/or configure a same IP address, instead of a plurality of public IP addresses (e.g., anycast IP addresses), corresponding to the intranet and/or the DNS server. However, a global DNS server may fail to enable or support pre-establishment of one or more connections to the intranet (e.g., to the application/backend server). Furthermore, a global DNS server may be unable to perform intelligent routing of application data/traffic based on a location of a client (e.g., whether a client is located inside or outside the intranet).

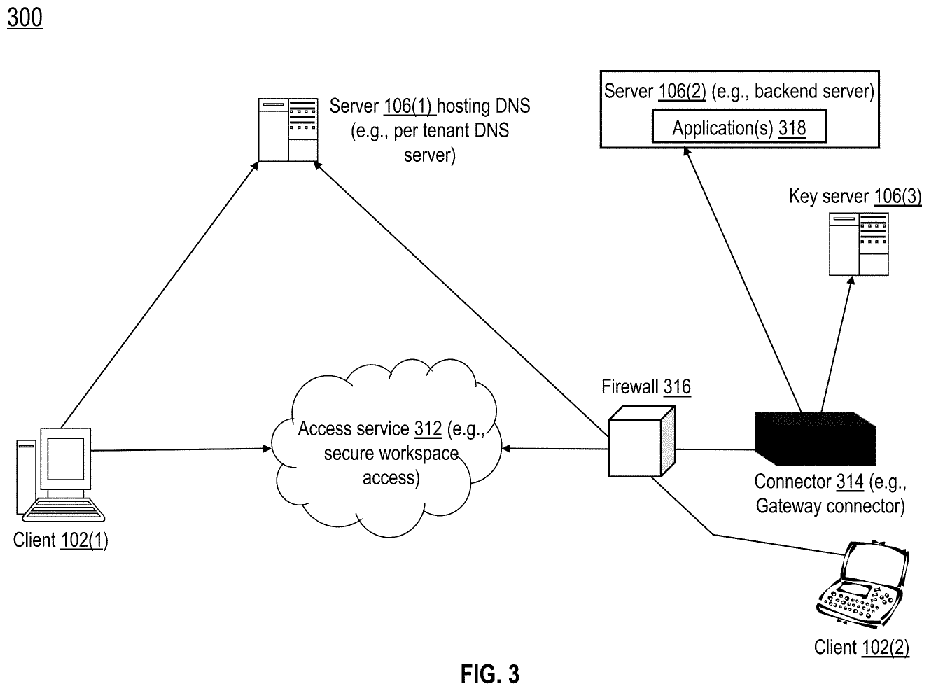

In view of the above discussion regarding accessing an application from outside an intranet, a process and/or system for accessing said application (e.g., via a server hosting a DNS configured for an intranet and/or an access service) may be beneficial, as further explained in the following passages. Referring to FIG. 3, depicted is a block diagram of one example embodiment of a system 300 for accessing one or more applications, e.g., without using a client agent. The system 300 may include one or more clients 102 of an entity, one or more servers 106 (such as a server hosting DNS 106(1), an application/backend server 106(2), and/or a key server 106(3)), an access service 312, one or more connectors 314, and/or a firewall 316. The server 106(2) can include or maintain or have access to at least one application 318, such as a web application.

Each of the above-mentioned elements or entities is implemented in hardware, or a combination of hardware and software, in one or more embodiments. Each component of the system 300 may be implemented using hardware or a combination of hardware or software detailed above in connection with FIG. 1C. For instance, each of these elements or entities can include any application, program, library, script, task, service, process or any type and form of executable instructions executing on hardware of a client device 102, a server 106 and/or a network device 200 in connection with FIGS. 1B-1C, for instance. The hardware includes circuitry such as one or more processors in one or more embodiments.

The system 300 may include one or more servers 106. The one or more servers 106 may include a server 106(1) hosting a DNS configured for an intranet (e.g., a DNS server 106(1)), an application server 106(2), a key server 106(3), and/or other servers. The DNS server 106(1) may be configured and/or designed to identify and/or determine an address (e.g., an IP address) for a particular web page and/or web application. For instance, a DNS server 106(1) may respond to one or more DNS requests/queries from a client 102. In some embodiments, the DNS server 106(1) may include a resolver, such as a DNS resolver hosted in the cloud. The DNS resolver may receive and/or obtain a request to access/use a web application from the client(s) 102. Responsive to receiving the request, the DNS resolver may determine and/or identify a corresponding address for the web application.

In some embodiments, at least one tenant (e.g., one or more users of a network, such as an intranet) may use and/or access a particular DNS server 106(1) and/or DNS resolver. In one example, a DNS server 106(1) can be configured for each tenant of a network (e.g., per-tenant DNS). As such, for a particular DNS server 106(1), each tenant may have access to and/or control over their own DNS entries. Because a DNS server 106(1) is configured for each tenant, each DNS server 106(1) can resolve the FQDN of a web application 318 to access the web application 318 without using a client agent, regardless of whether the client(s) 102 are inside or outside the intranet (e.g., intranet hosting the application 318). In some embodiments, each tenant may receive and/or obtain a unique anycast IP address (and/or other types of addresses) corresponding to (e.g., unique to and/or related to) the DNS server 106(1). The anycast IP address can be used to direct, route, send, forward, and/or transmit a DNS request from a client 102 to the DNS instance (e.g., DNS server 106(1)) located nearest/closest to the client 102. In some embodiments, the anycast IP address may belong to (e.g., correspond to) the DNS server 106(1). In some embodiments, a user of a client 102 may configure the client 102 to indicate that the anycast IP address corresponds to (e.g., is unique to and/or related to) the DNS server 106(1). In some embodiments, the DNS server 106(1) may include or correspond to a global DNS server.

In some embodiments, the DNS server 106(1) may receive a request to access a web application 318 (e.g., hosted in an intranet) from a client 102 that is outside the intranet. The DNS server 106(1) may send a notification to an access service 312 to cause the access service 312 to pre-establish a connection to the intranet. In some embodiments, the DNS server 106(1) may direct the client 102 to send a handshake message to the access service 312 to request access to the web application 318.

The application server 106(2) (e.g., a backend server and/or other servers 106) may be configured and/or designed to host one or more resources, services, and/or applications 318 (e.g., application resources, as a web application, SaaS application or remote-hosted network application). The application server 106(2) may be configured and/or designed to provision the one or more resources, services, and/or applications 318 to one or more clients 102 of a consumer or other entity (e.g., an organization or user), via one or more networks 104. For example, the client 102 may establish one or more sessions or connections (e.g., secured/encrypted or otherwise, such as a SSL connection) with the application server(s) 106(2) to access a service/resource/application 318, such as a web application. In another example, the application server(s) 106(2) may receive/obtain a request from the client 102 (e.g., via an access service 312 and/or at least one connector 314) to access/use one or more applications 318 (or establish the connections to access the one or more applications 318).

To provide a service/resource/application 318, the application server(s) 106(2) may execute, provide, provision, and/or host one or more network application(s). In some embodiments, a service/resource may be referred to interchangeably with an application 318, application resource or network application. An application 318 can for instance include a remote-hosted application, a remote-hosted desktop, a web application or a software-as-a-service (SaaS) application. A remote-hosted desktop may be a virtual desktop hosted on a server 106 which is accessed by or remotely provisioned to the client 102. In some embodiments, the delivery of a remote-hosted desktop may be via a session and/or connection based on High-Definition User Experience (HDX) or Independent Computing Architecture (ICA) display remoting protocol, or Remote Desktop Protocol (RDP). A remote-hosted application may include/correspond to an application service that can be delivered via a HDX-based, ICA-based, RDP-based, etc., session and/or connection. In some embodiments, a remote-hosted application may be an application which is installed on/in the remote-hosted desktop environment and is therefore accessible within the remote-hosted desktop. A SaaS application can be a centrally-hosted application which is typically accessible on a subscription basis. In some embodiments, the SaaS applications may include web-based applications. In other embodiments, the SaaS applications may correspond to remote-hosted applications and, therefore, can be delivered in HDX/ICA/RDP—based sessions and/or connections. SaaS applications and/or web applications may include for instance salesforce.com, SAP, Microsoft Office 365, Dropbox or Gmail service, Amazon web services, and so on.

The key server 106(3) (e.g., a keyless SSL server and/or other servers 106) may be configured and/or designed to enable protected and/or encrypted communication between the client(s) 102 and/or the application server 106(2) in the intranet. For instance, the key server 106(3) may perform and/or execute a handshake process (e.g., a SSL handshake) to establish/determine one or more encryption parameters (e.g., encryption algorithm and/or session key(s)) for a pre-established connection. During the handshake process, at least two entities (e.g., a client 102 and a server 106) may authenticate each other and/or establish/determine/generate at least one session key for a pre-established connection. The session key(s) can be used to transparently intercept and/or inspect traffic from/to the application (e.g., to provide services, such as SSO and/or web filtering functionalities). In one example, an access service 312 may access/use the key server 106(3) and/or at least one session key for a pre-established connection to the intranet. In some embodiments, a key server 106(3) can be used to encrypt/protect (e.g., SSL encryption) communication (e.g., messages) between the client(s) 102 and the application server 106(2). The communication may include traffic and/or data associated with an application 318 (e.g., a web application).

In some embodiments, the server(s) 106 (e.g., DNS server 106(1), application server 106(2), and/or key server 106(3)) can be part of a cloud or datacenter for instance. The server(s) 106 may include any embodiment of volatile memory 122 or non-volatile memory 128 (discussed in FIG. 1C for example) which may store files, data and/or content of the service. The server(s) 106 may communicate with other various components of the system 300 in FIG. 3 via a communications interface 118 for instance. Hence, the server(s) 106 may be similar in some aspects to the computer 101 described with reference to FIG. 1C.

The system 300 may include one or more clients 102, such as client 102(1) and/or client 102(2). The client 102 may include or correspond to devices of a consumer of the service. For example, if the consumer is an individual or user, the client 102 may comprise a smartphone, a laptop (e.g., at home), a tablet device, and a desktop computer (e.g., at work), that the user may use to access an application resource (e.g., Dropbox service) and/or other resources 304 at various times and/or locations for instance. In an example where the consumer is an organization, such as an enterprise, the consumer can extend over a number of users (e.g., management persons, staff members, IT administrators, and so on) and their associated client(s) 102 or devices (e.g., corporate-issued device, personally-owned devices, and/or registered/approved devices (e.g., in a BYOD program)). Any number of the users may access a service/resource/application 318 (e.g., salesforce.com, SAP, Microsoft Office 365) from a service/resource/application provider, via a corporate account for the service/resource/application 318 for instance.

The client(s) 102 may be configured and/or designed to access one or more applications 318 over one or more networks, such as an intranet. In some embodiments, the client(s) 102 may interact with the server(s) 106 (e.g., key server 106(3) and/or application server 106(2)) via at least one connector 314 (e.g., a device intermediary between the client(s) 102 and the server(s) 106), a firewall 316, and/or an access service 312. In one example, the client 102(1) may send a request (e.g., a request to access/use an application 318) and/or message (e.g. a HTTP message and/or other messages) to the server(s) 106 via the connector(s) 314, the access service 312, and/or the firewall 316. The request may include and/or specify a FQDN of at least one application 318 in an intranet and/or other information. As such, the request may include or correspond to a request to access and/or use the application 318 of the request. In some embodiments, the firewall 316 can include or correspond to an intermediary device and/or an appliance 200. In some embodiments, the client(s) 102 may be located inside and/outside the intranet (e.g., a private network). In certain embodiments, the client(s) 102 may be directed by a server 106 (e.g., the DNS server 106(1)) to send a handshake message (e.g., a ‘client hello’ message and/or other messages) to the access service 312. By sending the handshake message, the client(s) 102 can initiate and/or trigger the handshake process with the access service 312 and/or the key server 106(3).

The system 300 may include one or more connectors 314 (sometimes referred to as appliance(s) 200, gateway(s) 200, node(s), and/or application delivery controllers (ADCs)). A connector 314 may be configured and/or designed to serve as an intermediary between different elements of a computer and/or network environment, such as between client(s) 102, server(s) 106, network(s) 104, and/or other connectors 314 (e.g., as discussed above in connection with FIG. 2). In some embodiments, the connector(s) 314 may have a connection to an application server 106(3) hosting one or more applications 318. An access service 312 can pre-establish the connection (e.g., responsive to receiving a request to access at least one application 318) via at least one connector 314. In some embodiments, a key server 106(3) may be accessed via (or by using) one or more connectors 314. In some embodiments, a connector 314 may direct, send, and/or forward a request to decrypt a secret (e.g., premaster secret) to the key server 106(3), responsive to performing a SSL handshake, for example.

In some embodiments, the connector 314 may be located at various points or in various communication paths, for example between two networks 104, within a computing and/or network environment 100. In other embodiments, the connector 314 may be located on a network 104, such as a private network (e.g., an intranet). One or more connectors 314 may communicate with one another and/or work in conjunction to, for example, accelerate, protect and/or secure network traffic (e.g., web application traffic) between clients 102 and servers 106 and/or provide load balancing of servers 106 to process requests from clients 102. In some embodiments, the one or more connectors 314 may act as a proxy or access server to provide access to the one or more servers 106, provide security and/or act as a firewall 316 between the client 102 and the server 106, and/or provide a secure VPN connection from the client 102 to the server 106, such as a SSL VPN connection and/or provide encryption and decryption operations.

The system 300 may include at least one access service 312, such as a secure workspace access (SWA) service. The access service 312 may be configured and/or designed to provide an authenticated client 102 with access (e.g., conditional access) to one or more applications 318 (e.g., web applications). The access service 312 may include a set of security controls for the application(s) 318 (e.g., SaaS and/or enterprise web apps). The security controls may provide conditional access to the application(s) 318 and/or protect the actions of a user based on certain policies. In some embodiments, the access service 312 can include or correspond to a cloud-based service implemented in a cloud computing environment, such as the one described in FIG. 1D. In some embodiments, the access service 312 can pre-establish at least one connection (e.g., via at least one connector 314) to the intranet (e.g., an application server 106(2)). The access service 312 may pre-establish the connection(s) responsive to receiving a notification from a server 106 (e.g., DNS server 106(1)). In one example, the access service 312 may pre-establish a connection responsive to receiving a request to access at least one application 318 hosted in the intranet.

In some embodiments, a client 102 may request access to an application 318 via the access service 312. For instance, the request to access the application(s) 318 can be directed, forwarded, and/or routed to the access service 312 (e.g., from the DNS server 106(1) to the access service 312). In some embodiments, the access service 312 can include or correspond to an intermediary device and/or an appliance 200. In some embodiments, an administrator can publish and/or remove one or more applications 318 (e.g., internal applications) in/from the access service 312. If an application 318 is added and/or removed, the access service 312 may send and/or transmit a message to the DNS server 106(1), to add and/or remove the FQDN of the added/removed application from the server 106(1) (e.g., add or remove a DNS entry).

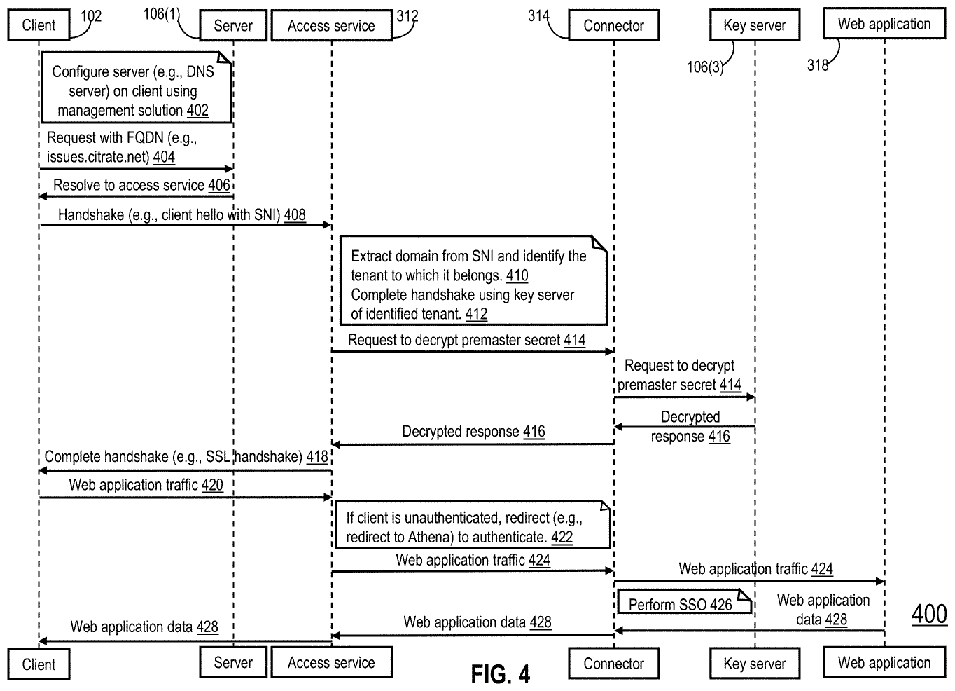

Referring now to FIG. 4, depicted is a communication diagram of an embodiment of a process 400 for accessing an application hosted in an intranet from outside the intranet. In accordance with process 400, a server 106(1) hosting a DNS configured for an intranet (e.g., a per-tenant DNS server 106(1)) may be configured on at least one client 102 (402). For instance, a user of a tenant may configure a unique anycast IP address corresponding to the server 106(1) on the client 102 (for example, by using an endpoint management solution such as CEM). Once the server 106(1) is configured on the client(s) 102, a client 102 may send and/or communicate a request (e.g., a DNS request) to the server 106(1) (404). The request may include or correspond to a request to access and/or use an application 318 hosted in the intranet. In some embodiments, the request may include, provide, specify, and/or indicate a FQDN of the application 318 hosted in the intranet (e.g., issues.citrate.net). Responsive to receiving the request with the FQDN, the server 106(1) may resolve the FQDN to a global FQDN of the access service 312 (406). As such, the server 106(1) may send a message to the client 102 to redirect the client 102 to the access service 312. Redirecting the client 102 to the access service 312 (e.g., responsive to resolving the FQDN of the request to the global FQDN) may cause the request (and/or a handshake message) to be directed, forwarded, and/or routed to the access service 312.

In some embodiments, the client 102 may send and/or transmit a handshake message (e.g., ‘client hello’ message) to the access service 312 (408). By sending the handshake message to the access service 312, the client 102 may initiate and/or trigger a handshake process (e.g., SSL handshake and/or transport layer security (TLS) handshake) between the client 102 and a server 106. In some embodiments, the handshake message may include an indication of the FQDN, such as a server name indication (SNI), and/or other information. Responsive to receiving the handshake message, the access service 312 may extract, determine, and/or identify a domain by using (or based on) the SNI of the handshake message (410). The access service 312 may determine and/or identify the tenant to which the extracted domain corresponds to. In some embodiments, the access service 312 may determine to complete and/or execute a handshake (e.g., a SSL handshake) by using and/or accessing a key server 106(3) (e.g., a keyless SSL server) (412). During a handshake, at least two entities (e.g., a client 102 and a server 106) may authenticate each other and/or establish/determine/generate at least one session key for a pre-established connection. The at least one session key can be used to encrypt one or more messages exchanged between the at least two entities. In some embodiments, the access service 312 may send a request to the key server 106(3) via at least one connector 314 (414). The request can be a request to decrypt a secret, such as a premaster secret. The request to decrypt the secret may include and/or provide the secret (e.g., a string of bytes) to the key (or keyless) server 106(3). The secret may be encrypted with a first key (e.g., a public key from a SSL certificate), wherein the key server 106(3) can decrypt the secret according to a second key (e.g., private key). Responsive to receiving the request to decrypt the secret, the key server 106(3) may send, transmit, and/or communicate a decrypted response (e.g., decrypted premaster secret) to the access service 312 via the connector 314 (416). Responsive to receiving the decrypted response, the access service 312 may complete and/or finalize the handshake process with the client 102 (418). As a result, communication (such as messages and/or requests) between the client 102 and the server 106(2) may be encrypted according to the key (or keyless) server and/or the at least one session key (e.g., created/generated during the handshake). For instance, web application data and/or traffic between the client 102 and the server 106(2) may be encrypted based on the at least one session key.

In some embodiments, the client 102 may send, transmit, and/or communicate traffic associated with the application 318 (e.g., web application traffic, such as a web application request) to the application 318 (e.g., hosted in the application server 106(2)) (420 and 424). The client 102 may send the traffic via the access service 312 and/or at least one connector 314. If the client 102 is unauthenticated, the access service 312 may redirect the client 102 (e.g., to an authentication service) to perform authentication/validation of the client 102, instead of forwarding the traffic to the connector 314 (422). Responsive to receiving the traffic, the application 318 may send and/or communicate application data to the client 102 via the connector 314 and/or the access service 312 (428). As such, the client 102 may access and/or use the application 318 hosted in the intranet. Prior to routing the application data via the connector 314, the connector 314 may perform a sign-on (e.g., single sign-on (SSO)) of the user of the client 102 (426).

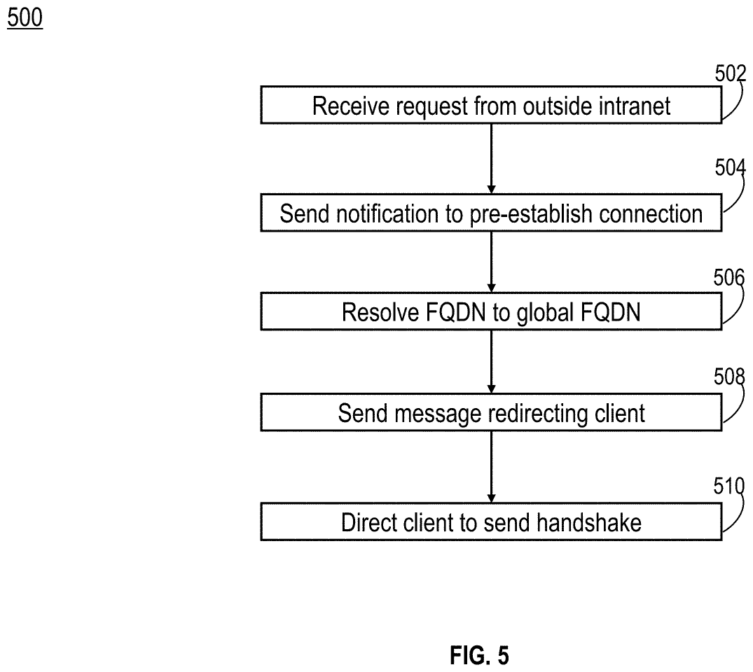

Referring to FIG. 5, depicted is a flow diagram of one embodiment of a method for accessing an application hosted in an intranet from outside the intranet. The functionalities of the method may be implemented using, or performed by, the components detailed herein in connection with FIGS. 1-4. In brief overview, a server 106(1) may receive a request from outside the intranet (502). The server 106(1) may send a notification to pre-establish at least one connection (504). The server 106(1) may resolve a FQDN to a global FQDN (506). The server 106(1) may send a message redirecting a client 102 to the access service 312 (508). The server 106(1) may direct the client 102 to send a handshake message to the access service 312 (510).

Referring now to operation (502), and in some embodiments, a server 106(1) (e.g., a server hosting a DNS configured for an intranet, such as a per-tenant DNS server) may receive and/or obtain a request from outside an intranet (e.g., a private network, such as a corporate and/or organization network). For instance, a client 102 that is outside the intranet may send, communicate, and/or transmit a request to the server 106(1). The request from the client 102 may include or correspond to a request to access and/or use an application 318 (e.g., web application and/or SaaS application) hosted in the intranet. In some embodiments, the request may include, specify, and/or provide a configured IP address, a FQDN of the application, and/or other information. The client 102 may send the request to a corresponding server 106(1) based on (or according to) the configured IP address (e.g., anycast IP address and/or other types of addresses). Management solutions, such as endpoint management solutions (e.g., CEM), can configure/specify the IP address in the client 102. The IP address may correspond to (e.g., unique to and/or related to) the server 106(1) and/or the intranet. In one example, if the IP address of the request corresponds to the intranet and/or the server 106(1), the request from the client 102 can be sent to the server 106(1), wherein the IP address is unique to the server 106(1) (e.g., DNS server). In some embodiments, the IP address can be used to direct, route, send, forward, and/or transmit a request (e.g., a request to access an application 318) from the client 102 to the server 106(1) (e.g., DNS instance) located nearest/closest to the client 102.

Referring now to operation (504), and in some embodiments, the server 106(1) may send, transmit, and/or forward a notification to pre-establish at least one connection. For instance, responsive to the FQDN of the application (e.g., responsive to receiving a request including the FQDN), the server 106(1) may send a notification and/or message to an access service 312 (e.g., SWA and/or other services providing conditional access to applications 318). The notification from the server 106(1) may cause the access service 312 to pre-establish and/or pre-configure at least one connection to the intranet (e.g., to the application server 106(2) hosting the application 318 specified via the request). In some embodiments, the pre-established connection(s) may be used (e.g., to access an application 318) if the request to access the application 318 is determined to be valid (e.g., by the access service 312, the connector 314, and/or the server 106(1)). Furthermore, and in certain embodiments, the connection(s) can be pre-established if the request originates (e.g., is sent) from a trustworthy IP address (e.g. a client device 102 with a trustworthy IP address). In some embodiments, the access service 312 may pre-establish the connection(s) (e.g., caused by the server 106(1), for instance) using at least one connector 314. The connector(s) 314 may include or correspond to a network node, an intermediary device, an appliance 200, a gateway connector, an application delivery controller (ADC) and/or other devices. In some embodiments, the connector(s) 314 may have a connection to an application server 106(2) hosting one or more applications 318, such as a web application. As such, the connector(s) 314 may facilitate and/or enable communication (e.g., application data and/or traffic) between the client 102, the server 106(1), the access service 312, a key server 106(3), and/or the application server 106(2).

In some embodiments, the access service 312 may request, obtain, and/or receive (e.g., caused by the server 106(1), for instance) a client certificate from the client 102. The client certificate may include or correspond to a trusted certificate used by the client 102 to send and/or transmit authenticated requests to a server 106(1). The server 106(1) may use the client certificate (e.g., information within) to confirm/authenticate/validate the identity of the client 102. In some embodiments, management solutions (e.g., CEM) can be used to distribute and/or provide the client certificate to one or more client devices 102. The client certificate may include information associated with the intranet, such as tenant information. For example, the client certificate may include a tenant ID and/or a user ID. The access service 312 (e.g., multi-tenant service) may use the client certificate to determine/identify a FQDN (e.g., included in a SNI) and/or determine/identify a particular connector 314 and/or key server 106(3). In some embodiments, the access service 312 may use the client certificate to identify and/or determine whether any connections have been pre-established for a particular client 102 (e.g., the client 102 providing the client certificate). For example, the server 106(1) may cause the access service 312 to identify a pre-established connection according to (or by using) the information associated with the intranet or tenant (e.g., provided by the client certificate). In some embodiments, the access service 312 may use an indication of the FQDN in a handshake message (e.g., FQDN in SNI of the request) to identify a pre-established connection. If no connection associated with the relevant client, tenant, connector and/or application server has been pre-established (e.g., according to the client certificate), the access service 312 may establish one or more connections to the intranet, such as to an application server 106(2) hosting the requested application 318.

Referring now to operation (506), and in some embodiments, the server 106(1) may resolve a FQDN to a global FQDN. In one example, the server 106(1) may receive (e.g., from the client 102) a request to access an application 318. The request may include, provide, specify, and/or indicate the FQDN of the application 318 in the intranet. Responsive to receiving the request, the server 106(1) may resolve the FQDN of the request to a global FQDN of the access service 312. Resolving the FQDN can include or correspond to translating the FQDN of the request to the global FQDN of the access service 312. Moreover, the server 106(1) may send, transmit, and/or communicate a message to the client 102, such that the message redirects the client 102 to the access service 312 (508). As such, redirecting the client 102 to the access service 312 (e.g., responsive to resolving the FQDN of the request to the global FQDN) may cause the request (e.g., request to access a web application) to be directed, forwarded, and/or routed to the access service 312.

Referring now to operation (510), and in some embodiments, the server 106(1) may cause, direct and/or instruct the client 102 to send and/or communicate a handshake message (e.g., a SSL handshake message) to the access service 312. For instance, responsive to the FQDN of the application 318 (e.g., responsive to receiving a request including the FQDN), the server 106(1) may direct, inform, and/or instruct the client 102 to send and/or communicate a handshake message to the access service 312. The client 102 may request access to the application 318 by sending the handshake message to the access service 312. In some embodiments, the server 106(1) may send and/or transmit a notification to the access service 312 (e.g., to pre-establish one or more connections) prior to the client 102 sending the handshake message to the access service 312. As such, the access service 312 may pre-establish one or more connections to the intranet prior to the client 102 sending the handshake message to the access service 312. In some embodiments, a handshake message can trigger, initiate, and/or enable encrypted communication (e.g., SSL encryption) between the client 102, the access service 312, the connector(s) 314, and/or the server 106(2) hosting the application 318 (e.g., application server 106(2)). In some embodiments, a key (or keyless) server 106(3) can be used to initiate and/or enable said encrypted communication. For instance, the access service 312 may access and/or use the key server 106(3) and/or at least one session key for the pre-established connection. In one example, the access service 312 may communicate with (and/or access) the key server 106(3) to establish one or parameters of the encryption (e.g., SSL encryption), and/or to determine/select at least one session key for a pre-established connection. Once the key server 106(3) and/or the at least one session key have been accessed (e.g., by the access service 312), encrypted messages may be exchanged between the client 102, the access service 312, the connector(s) 314, and/or the application server 106(2).

In some embodiments, the server 106(1) may receive and/or obtain a message from the access service 312. The message can be a message to add and/or remove the FQDN of at least one application (e.g., web application). For example, the server 106(1) may receive a message to add and/or remove the FQDN from a storage and/or memory of the server 106(1). In some embodiments, the server 106(1) may receive the message from the access service 312 responsive to the publication (e.g., by an administrator) of at least one application via the access service 312. In another example, the server 106(1) may receive the message from the access service 312 responsive to the removal (e.g., by an administrator) of at least one application from the access service 312. In some embodiments, another server 106 hosting a DNS configured for another intranet may receive and/or obtain a request from another client 102. The another client 102 can be outside the another intranet. The request may include or correspond to a request to access an application (e.g., a web application) hosted in the another intranet. In some embodiments, the request may include, provide, specify, and/or indicate a FQDN of the application in the another intranet. In certain embodiments, the another server 106 may send, transmit, and/or communicate a notification to an access service 312 (e.g., another access service 312). The another server 106 may cause, via the notification, the access service 312 to pre-establish at least one connection to the another intranet. In some embodiments, the another server 106 may direct the another client 102 to send a handshake message to the access service to request access to the application 318 in the another intranet.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
receiving, by a server hosting a domain name service (DNS) configured for an intranet, a request from a client that is outside the intranet to access a web application hosted in the intranet, the request including a fully qualified domain name (FQDN) of the web application in the intranet;
sending, by the server responsive to the FQDN of the web application in the intranet, a notification to an access service, to cause the access service to pre-establish a connection to the intranet; and
directing, by the server responsive to the FQDN of the web application in the intranet, the client to send a handshake message to the access service to request access to the web application.

2. The method of claim 1, wherein sending the notification comprises:
sending, by the server, the notification prior to the client sending the handshake message to the access service.

3. The method of claim 1, wherein the request includes an anycast internet protocol (IP) address corresponding to the server.

4. The method of claim 1, comprising:
resolving, by the server, the FQDN to a global FQDN of the access service; and
sending, by the server to the client, a message to redirect the client to the access service.

5. The method of claim 1, comprising:
receiving, by the server from the access service, a message to add or remove the FQDN of the web application.

6. The method of claim 1, comprising:
receiving, by another server hosting a DNS configured for another intranet, a request from another client that is outside the another intranet to access a web application hosted in the another intranet, the request including a FQDN of the web application in the another intranet;
sending, by the another server, a notification to another access service, to cause the another access service to pre-establish a connection to the another intranet; and
directing, by the another server, the another client to send a handshake message to the another access service to request access to the web application in the another intranet.

7. The method of claim 1, comprising:
causing the access service to pre-establish the connection to the intranet using a connector having a connection to an application server hosting the web application.

8. The method of claim 1, comprising:
causing the access service to request or receive a client certificate from the client, the client certificate including information associated with the intranet; and
causing the access service to identify the pre-established connection using the information associated with the intranet and an indication of the FQDN in the handshake message.

9. The method of claim 7, wherein the access service accesses a key server or at least one session key for the pre-established connection.

10. A server hosting a domain name service (DNS) configured for an intranet, comprising:
at least one processor configured to:
receive a request from a client that is outside the intranet to access a web application hosted in the intranet, the request including a fully qualified domain name (FQDN) of the web application in the intranet;
send, responsive to the FQDN of the web application in the intranet, a notification to an access service, to cause the access service to pre-establish a connection to the intranet; and
direct, responsive to the FQDN of the web application in the intranet, the client to send a handshake message to the access service to request access to the web application.

11. The server of claim 10, wherein the at least one processor is configured to:
send the notification prior to the client sending the handshake message to the access service.

12. The server of claim 10, wherein the request includes an anycast internet protocol (IP) address corresponding to the server.

13. The server of claim 10, wherein the at least one processor configured to:
resolve the FQDN to a global FQDN of the access service; and
send a message to the client to redirect the client to the access service.

14. The method of claim 1, wherein the at least one processor configured to:
receive a message from the access service to add or remove the FQDN of the web application.

15. The server of claim 10, wherein another server hosting a DNS configured for another intranet is configured to:
receive a request from another client that is outside the another intranet to access a web application hosted in the another intranet, the request including a FQDN of the web application in the another intranet;
send a notification to another access service, to cause the another access service to pre-establish a connection to the another intranet; and
direct the another client to send a handshake message to the another access service to request access to the web application in the another intranet.

16. The server of claim 10, wherein the at least one processor configured to:
cause the access service to pre-establish the connection to the intranet using a connector having a connection to an application server hosting the web application.

17. The server of claim 10, wherein the at least one processor configured to:
cause the access service to request or receive a client certificate from the client, the client certificate including information associated with the intranet; and
cause the access service to identify the pre-established connection using the information associated with the intranet and an indication of the FQDN in the handshake message.

18. The server of claim 17, wherein the access service accesses a key server or at least one session key for the pre-established connection.

19. A non-transitory computer readable medium storing program instructions for causing at least one processor of a server hosting a domain name service configured for an intranet, to:
receive a request from a client that is outside the intranet to access a web application hosted in the intranet, the request including a fully qualified domain name (FQDN) of the web application in the intranet;
send, responsive to the FQDN of the web application in the intranet, a notification to an access service, to cause the access service to pre-establish a connection to the intranet; and
direct, responsive to the FQDN of the web application in the intranet, the client to send a handshake message to the access service to request access to the web application.

20. The non-transitory computer readable medium of claim 19, wherein the program instructions cause the at least one processor to:
resolve the FQDN to a global FQDN of the access service; and send
a message to the client to redirect the client to the access service.
